(19) United States
(12) Patent Application Publication
(10) Pub. No.: US 2010/0030892 A1
(43) Pub. Date: Feb. 4, 2010

(54) GIS BASED NETWORK INFORMATION MONITORING-SYSTEM

(75) Inventors: Chi Yoon Jeong, Daejeon (KR); Beom Hwan Chang, Daejeon (KR); Seon Gyoung Sohn, Daejeon (KR); Geon Lyang Kim, Daejeon (KR); Jong Hyun Kim, Daejeon (KR); Jong Ho Ryu, Cheonan-si (KR); Jung Chan Na, Daejeon (KR); Hyun Sook Cho, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/471,005

(22) Filed: May 22, 2009

(30) Foreign Application Priority Data
Jul. 30, 2008 (KR) 10-2008-0074726

(51) Int. Cl. G06F 15/173

(52) U.S. Cl. 709/224

(57) ABSTRACT

Disclosed is a GIS based network information monitoring system that intuitively combines GIS based geographic information with traffic information and a security event, expresses the combined geographic information on a display, and does not need position calibration of network information when the traffic information and the security event are expressed. The GIS based network information monitoring system includes: a geographic information processing module receiving network information from an external network device, containing GIS based geographic information, and creating geographic information corresponding to location information in response to the location information; and a network information processing module mapping the network information to geographic information corresponding to the location information to express the mapped network information, connecting an attack site of a packet causing a security problem, an intermediate site, and a target site using lines, and intuitively expressing the network information by varying the widths and colors of the lines according to the attack type and danger level of the packet.

### CROSS-REFERENCE TO RELATED APPLICATION

This application claims priority from Korean Patent Application No. 10-2008-0074726 filed on Jul. 30, 2008 in the Korean Intellectual Property Office, the disclosure of which is incorporated herein by reference in its entirety.

### BACKGROUND

The present invention relates to a network information monitoring system, and more particularly, to a GIS based network information monitoring system that intuitively combines GIS based geographic information with traffic information and a security event, expresses the combined geographic information on a display, and does not need position calibration of network information when the traffic information and the security event are expressed.

The present invention was suggested from a study that had been performed as a part of a research & development program in information and communication technologies of the Korean Ministry of Information and Communication and the Institute for Information Technology Advancement (IITA) [Project No. 2007-S-022-02, Project name: DEVELOPMENT OF INTELLIGENT SYSTEM FOR MONITORING AND TRACING CYBER ATTACK IN AII-IP ENVIRONMENT].

Needs for management of network security systems are gradually increasing.

Some security companies and network managers combine network element information (for example, the position, IP, and other natural information of a network device) with a security event and express it on a map (or map-shaped image) to utilize it in network security, or iconize network devices (for examples, routers, switches, and hosts) and express them in a logical space (image) representing connections among them to manage network security.

Then, network managers need to directly select the positions of network devices or express them on a map with reference to location information (based on latitudes and longitudes) of the network devices. The location information of the network device whose locations are determined by network managers is stored in a database to be used in mapping with geographic information later.

Since the location information of network devices stored in a database is expressed as not the actual physical locations but the relative locations of network devices in a map or an image, the location information of the network device needs to be reset when a map (or an image or a logical space).

In order to solve the problem, a paper titled “Geographical NetFlows Visualization for Network Situational Awareness: NaukaNet Administrative Data Analysis System (NADAS)” (hereinafter, referred to as “recited paper”) disclosed in 12^{th} International Conference on Telecommunication Systems—Modeling and Analysis (ICTSM) suggested a web based IP monitoring system that expresses data traffic and statistical values for the traffic.

The web based IP monitoring system enables a network manager to recognize an epicenter causing network traffic and the amount of traffic by checking the approximate location of a network device using IP information and expressing the network device on a map. In this case, the web based IP monitoring system expresses traffic causing site in a two-dimensional map image based on latitude and longitude.

The web based IP monitoring system obtains latitude and longitude information about a network device using IP, but generates errors in the actual location of the network device that is expressed on a map and the location of a network traffic causing site when the spherical earth is mapped onto a planar map. The errors gradually increase as the network device is spaced apart further from the network manager. Furthermore, in the web based IP monitoring system, a basic problem of resetting a coordinate when a map image expressing a network traffic causing site cannot be solved and enlargement or reduction of a map image is restricted by the resolution of an image itself.

If the web based IP monitoring system disclosed in the recited paper is to map the location information acquired through IP to an actual coordinate of the spherical earth, a network device needs to be mapped again in a map image located on a two-dimensional plane in consideration of the coordinate characteristics of the earth having a three-dimensional coordinate system. However, calibration of locations is not simple and is so time-consuming that the web based IP monitoring system is not suitable for a network system whose traffic needs to be monitored in real time.

### SUMMARY

The present invention provides a GIS based network information monitoring system that maps security information and network element information with GIS based geographic information and expresses them so that a network manager does not need to express a network device and a situation on a map through a separate operation.

The present invention also provides a GIS based network information monitoring system that maps network element information to vector based GIS location information so that resolution is not decreased even when a network manager enlarges or reduces (zooms in or zooms out) a site where the network element information is expressed.

The present invention also provides a GIS based network information monitoring system that expresses the position, traffic causing site, attack site, and geographic information of a network device in the form of diagram using information that can be mapped through GIG based geographic information such as an address, a phone number, and a company name in addition to an IP address so that a network manager intuitively recognize and cope with a network situation.

The present invention also provides a GIS based network information monitoring system that assigns different colors and thicknesses according to the amount of traffic, the state of a network device, and the speed (use frequency) of a network cable so that a network manager intuitively recognizes the state of a network pertaining to himself or herself.

Therefore, the present invention has been made in view of the above problems, and it is an object of the present invention to provide a GIS based network information monitoring system comprising: a geographic information processing module receiving network information from an external network device, containing GIS based geographic information, and creating geographic information corresponding to location information in response to the location information; and a network information processing module mapping the network information to geographic information corresponding to the location information to express the mapped network information, connecting an attack site of a packet causing a security problem, an intermediate site, and a target site using lines, and intuitively expressing the network information by varying the widths and colors of the lines according to the attack type and danger level of the packet.

It is another object of the present invention to provide a GIS based network information monitoring system of claim comprising: an event processing module connected to a GIS provider system providing a GIS service by a network to receive at least one of traffic information, IP information, security event information, network element information from at least one of a network switch and a network security device; and a network information processing module determining a location causing at least one of traffic and the security event through the IP information, requesting geographic information containing the determined location from the GIS provider system, and connecting the attack site and target site causing one of the traffic and the security event to the acquired geographic information to intuitively express the connected attack site and target site in the geographic information.

According to the present invention, a network manager can easily and intuitively recognize the route and type of a network attack by connecting an attack site where a network attack is started, a target site of a network attack, and an intermediate site to GIS based geographic information using lines.

Further, unlike a conventional image based map mapping method, it is unnecessary to reset or change location information and network information of a network device to a map changed by a network manager even when the geographic information is changed.

Furthermore, a network manager can intuitively recognize and cope with a network situation by displaying the position of a network device, a traffic causing site, an attack site, and geographic information using information, such as an address, a phone number, and a company name, which can be mapped through GIS based geographic information in addition to an IP address acquired through a network switch or a security device.

### BRIEF DESCRIPTION OF DRAWINGS

The above and other objects, features and other advantages of the present invention will be more clearly understood from the following detailed description taken in conjunction with the accompanying drawings, in which:

FIG. 1 is a block diagram of a GIS based network information monitoring system according to the first embodiment of the present invention;

FIG. 2 is a view illustrating an example of expressing an attack site, an intermediate site, and a target site in lines in geographic information;

FIG. 3 is a block diagram of a GIS based network information monitoring system according to the second embodiment of the present invention;

FIG. 4 is a view illustrating an example of a screen on which a security event is displayed by a GIS based network information monitoring system;

FIG. 5 is a view illustrating an example of a screen displayed when the screen of FIG. 4 is enlarged by manipulation of a network manager; and

FIG. 6 is a view illustrating an example of a screen that displays element information of a network in a GIS based network information monitoring system according to the present invention.

### DETAILED DESCRIPTION

Hereinafter, exemplary embodiments of the present invention will be described in detail with reference to the accompanying drawings.

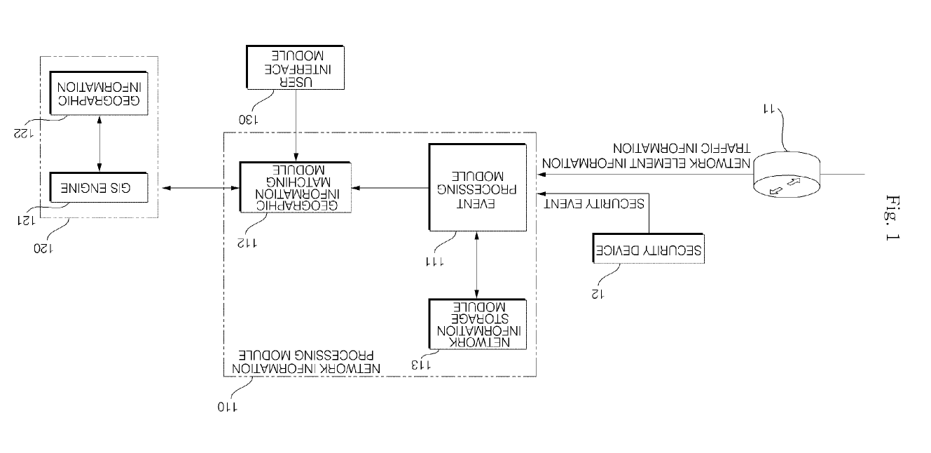

FIG. 1 is a block diagram of a GIS based network information monitoring system according to the first embodiment of the present invention.

The illustrated GIS based network information monitoring system includes a network information processing module 110 and a geographic information processing module 120.

The network information processing module 110 receives network element information, traffic information, a security event, and IP information through a security device 12 or a network switch 11, and determines the attack site of a packet excessively generating network traffic or a packet causing a security event through the received IP information and network element information.

After determining the attack site causing a security event or excessive traffic through IP information, the network information processing module 110 requests geographic data about the attack site from the geographic information processing module 120. The geographic information is GIS based geographic information, and can be written in a 2D or 3D manner.

The network information processing module 110 maps an attack site, an intermediate site, and a target site to the geographic information acquired from the geographic information processing module 120.

After mapping the attack site, the intermediate site, and the target site to geographic information, the network information processing module 110 connects the sites with lines to enable a network manager to intuitively recognize a network attach route. The intermediate site and the target site are generally a network device, an autonomous system (AS), an Internet service provider (ISP), or a company and are expressed with an icon or a table, so that a network manager can easily recognize them.

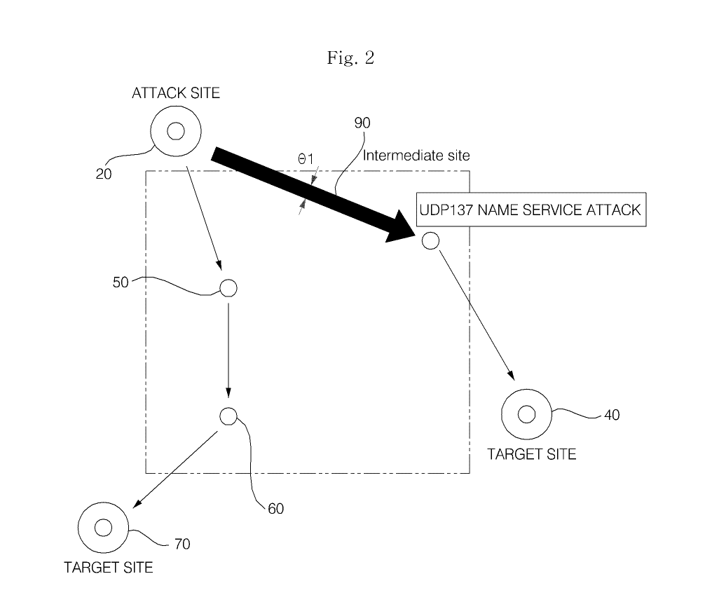

The mapping result uses lines so that a network manager can intuitively understand it. Then, the colors and thicknesses of the lines are varied according to the amount of traffic and the type of attack. The lines will be described with reference to FIG. 2.

FIG. 2 is a view illustrating an example of expressing an attack site, an intermediate site, and a target site in lines in geographic information.

In the drawing, lines whose thickness D1 is determined according to the amount of network traffic and whose color is determined according to the type of network attack are expressed between the attack site 20 and the intermediate site 30. A box-like menu representing the type of the attack delivered at the attack site 20 is expressed on one side of the intermediate site 30.

The type of a network attack such as “UDP 137 name service attack” is expressed in the drawing. The target sites correspond to the reference numerals 40 and 70 and the lines (for example, the reference numeral 90) are connected from the attack site 20 to the intermediate site and the target site. Accordingly, the network manager can intuitively recognize the attack route through which a network attack is delivered, the type of attack, and how much traffic is generated by the network attack in a short time period.

In the drawing, the color of the line 90 may be expressed as green during a normal state and as red during an abnormal state by applying a general concept, but colors may be endowed in advance according to the type of an attacks and the color of the line may be determined. In addition, although illustrated in detail, the drawing (FIG. 2) is expressed on 2D or 3D GIS based geographic information in which buildings, land forms, and roads are expressed.

Preferably, the network information processing module 110 includes an event processing module 111, a network information storage module 113, and a geographic information mapping module 112.

The event processing module 111 receives traffic information, IP information, security event information, and network element information through the network switch 11 or the security device 12. Then, the network switch 11 and the security device 12 may be a device that performs a monitoring operation according to a NetFlow monitoring method or an sFlow monitoring method. In the NetFlow monitoring method, after packet information elements received from outside are buffered, they are examined and are internally transmitted if the examination result is good. In the sFlow monitoring method, a network attack is detected through sampling of packets. The monitoring operations by the NetFlow monitoring method and the sampling method are preferably performed by network switches or routers through which all traffic passes through. In addition to the above-mentioned NetFlow monitoring method or sFlow monitoring method, various detection methods may be used to detect attacks by the security device 12.

After the event processing module 111 extracts various IP information such as the original IP address and destination IP address of a packet and the IP address of network equipment from the security event and network element information recognized through the network switch 11 or the security device 12, the network information storage module 113 extracts detailed information about the corresponding IP. If the network information (traffic information, IP information, security event information, and network element information) stored in the network information storage module 113 contains location information about latitudes and longitudes, a network manager can select latitude and longitude information using network information or select latitude and longitude information that may be acquired through IP.

Here, a security event refers to traffic data of NetFlow or sFlow that includes IP information about the start location and destination location of a packet, and alarm data generated in a security device such as a firewall or an intrusion detection system. Further, network element information refers to IP addresses of network devices such as hosts and routers that constitute a network, connection information between network devices, and detailed information (interface and system information) of network devices.

The network information storage module 113 contains information of an autonomous system (AS), an Internet service provider (ISP), a company, and a management domain, and contains the IP ranges, phone numbers, addresses, latitudes and longitudes of the AS, ISP, company, and management domain. The information contained in the network information storage module 113 may be constructed using a database or may be in the form of individual files.

After the geographic information mapping module 112 requests and receives geographic information for displaying network information from the GIS engine 121 of the geographic information processing module 120, it maps the network information provided from the event processing module 111 to the geographic information to express it on a screen. When the geographic information mapping module 112 maps geographic information and network information, it does not simply use latitude and longitude data extracted from the network information storage module 113 but provides information such as an address, a phone number, and a company name to the GIS engine 121. The geographic information mapping module 112 compares latitude and longitude data extracted through the GIS engine 121 with the location information contained in the network information storage module 113, and if the latitude and longitude data is below a critical value determined by the system, the latitude and longitude data extracted by the network information storage module 113 are used.

When a location error of a network device is above a predetermined critical value, the geographic information mapping module 112 newly calculates latitude and longitude data using a calibration method such as a method of obtaining an average from a plurality of latitude and longitude data and a method of selecting a data whose error is the smallest by comparing latitude and longitude data with the remaining data.

The geographic information mapping module 112 maps network information to geographic information with reference to a zoom-in or zoom-out which a network manager has set to the geographic information through the user interface module 130. If a network manager wants to enlarge geographic information through an input unit such as a keyboard or a mouse, the geographic information needs to be enlarged, or otherwise, it needs to be reduced. If a network manager wants to use a bitmap image as geographic information, the resolution of the geographic information is apparently decreased when the geographic information is enlarged or reduced. In order to solve this problem, the geographic information is realized by a vector image. A bitmap image that realizes an image using numerous dots has a clear original image, but when the original image is enlarged, the dots are dithered, in which case the image is blurred and is not clear. Accordingly, in the embodiment of the present invention, geographic information is created using a vector image that is rarely damaged even when it is enlarged or reduced, and network information such as a network device, an attack site, a target site, an intermediate site, and the type of an attack is expressed in vector image based geographic information using icons, lines, and texts.

The geographic information processing module 120 creates geographic information with respect to location information requested by the network information processing module 110 to feedback the created geographic information.

The geographic information processing module 120 includes a geographic information storage module 122 containing map data and a GIS engine 121 that selects a desired region from the geographic information storage module 122 with reference to the location information provided by the network information processing module 110 and feedbacks the selected region to the network information processing module 110.

Spatial data and attribute data are defined together in the geographic information stored in the geographic information storage module 122. The attribute data define various characteristics with respect to the location or region expressed by the spatial data. For example, the attribute data can be mapped with the spatial data such as air pollution information, water-purity information, and weather information and can help variously determine the characteristics of a space. In the embodiment of the present invention, network information corresponds to the attribute data.

The GIS engine 121 connects, manipulates, manages, and outputs the spatial data and the attribute data. When a demand is made by the information mapping module 112, after creating geographic information, the GIS engine 121 provides the created geographic information to the geographic information mapping module 112.

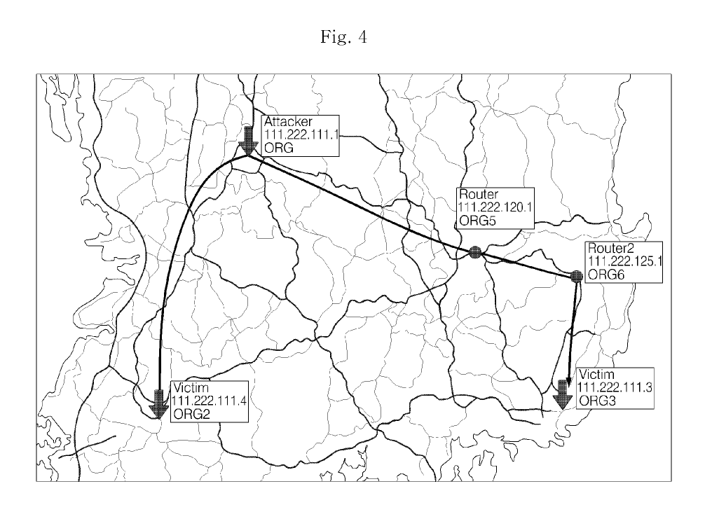

FIG. 4 is a view illustrating an example of a screen on which a security event is displayed by a GIS based network information monitoring system.

Referring to FIG. 4, the screen displayed according to the present invention expresses information related to an attacker delivering a network attack, a victim hose, an intermediate site (for example, an intermediate router via which an attack is delivered), and a network using polygons and letters on the basis of geographic information, and expresses the type or strength of a network attack through the thickness and color of a connection line between an attacker and a victim or an attacker and an intermediate system.

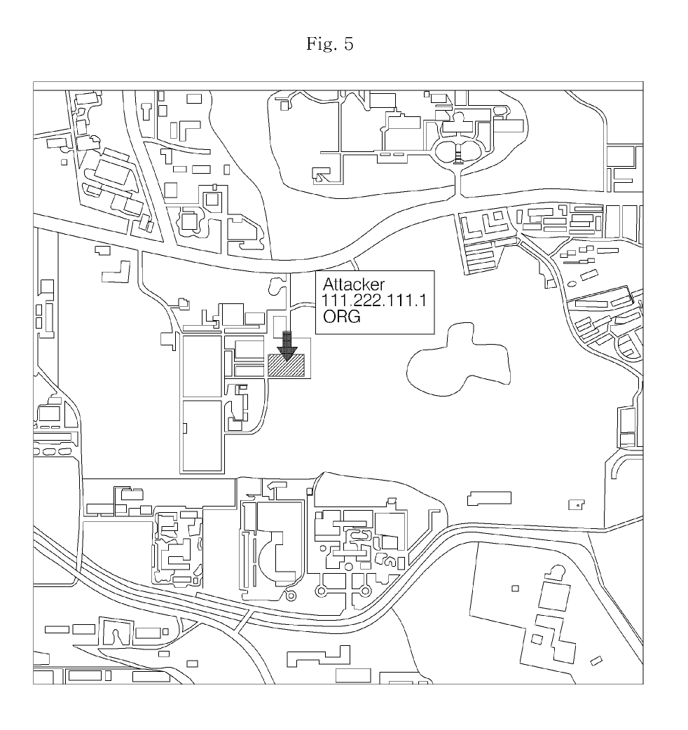

FIG. 5 is a view illustrating an example of a screen displayed when the screen of FIG. 4 is enlarged by manipulation of a network manager.

Referring to FIG. 5, the screen displayed according to the present invention uses GIS based geographic information to enlarge the geographic information while increasing the precision of the geographic information according to manipulation of the user, or provides a screen recognizable by the user when the geographic information is reduced while decreasing the precision of the geographic information.

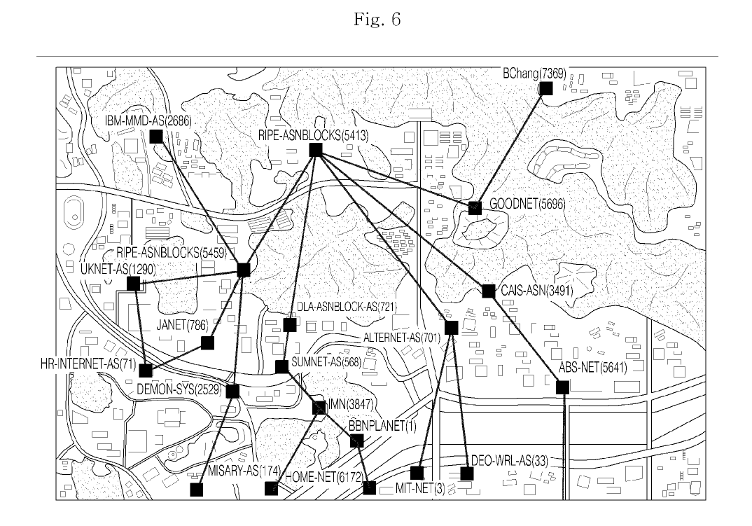

FIG. 6 is a view illustrating an example of a screen that displays element information of a network in a GIS based network information monitoring system according to the present invention. Referring to FIG. 6, the geographic location of a network device, such as a router or a host, which constitute a network is automatically determined with a user (a network manager) not being separately concerned, by using the information extracted through the network information storage module 113 and the GIS based geographic information.

In addition, even when a user enlarges or reduces geographic information, the recognition of the user can be improved by displaying recognizable high-precision geographic information. The shape, size, and color of a network express the performance, current state, and error of network equipment, and the thicknesses and colors of connection lines between network equipment express the speeds and use frequencies of connection cables.

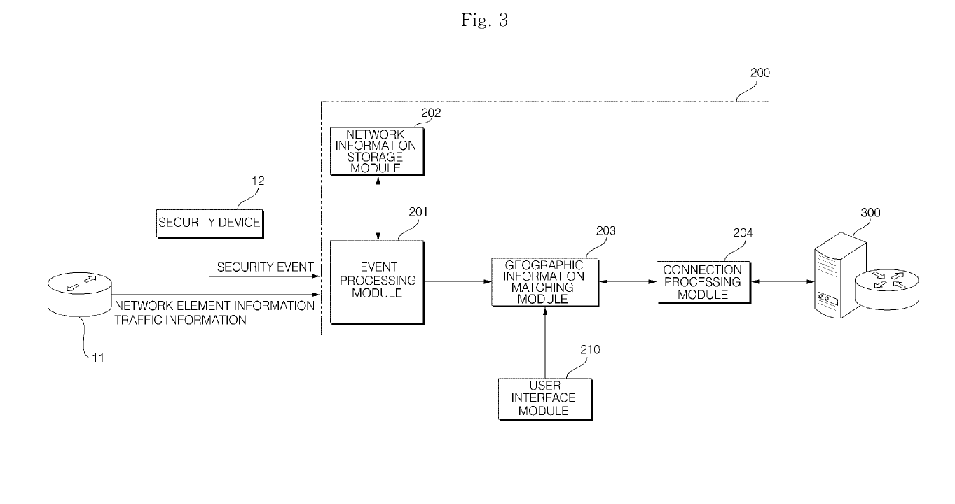

FIG. 3 is a block diagram of a GIS based network information monitoring system according to the second embodiment of the present invention.

The second embodiment of the present invention is similar to the embodiment explained through FIG. 1, but geographic information is acquired by an external GIS provider system 300 connected to a network to reduce the burden of a GIS based network information monitoring system. Accordingly, the GIS provider system 300 takes the roll of the geographic information processing module 120 of the first embodiment of the present invention explained through FIGS. 1, 2, 4, 5, and 6, and the rolls of the remaining elements are the same. The GIS based network information monitoring system 200 according to the embodiment of the present invention transmits location information to the external GIS provider system 300, and a connection processing module 204 acquires geographic information through the GIS provider system 300. Accordingly, the descriptions of the elements having functions the same as or similar to those of the first embodiment of the present invention will not be repeated.

Meanwhile, the GIS based network information monitoring system explained through FIGS. 1 to 6 has the form of a system or a device, but may be realized in the form of a program. In this case, it includes a memory or a processor and may be installed in a user terminal (for example, a computer, a PDA, a cellular phone, and a laptop computer) that can be connected to a network to be driven.

The present invention can be applied to a network security field.

1. A GIS based network information monitoring system comprising:
a geographic information processing module receiving network information from an external network device, containing GIS based geographic information, and creating geographic information corresponding to location information in response to the location information; and
a network information processing module mapping the network information to geographic information corresponding to the location information to express the mapped network information, connecting an attack site of a packet causing a security problem, an intermediate site, and a target site using lines, and intuitively expressing the network information by varying the widths and colors of the lines according to the attack type and danger level of the packet.

2. The GIS based network information monitoring system of claim 1, wherein the network information is one of traffic information, IP information, a security event, and network element information.

3. The GIS based network information monitoring system of claim 2, wherein the network element information contains natural information of the network device causing the traffic and the security event, and the network information processing module expresses the attack site, intermediate site, and target site of the packet causing one of the traffic and the security event by using the lines through the IP information.

4. The GIS based network information monitoring system of claim 3, wherein the network information processing module processes the network device corresponding to one of the attack site, the destination, and the target site with an icon.

5. The GIS based network information monitoring system of claim 3, wherein the network information processing module acquires address information about one of an autonomous system (AS), an Internet service provider (ISP), and a company of the IP causing at least one of the traffic and the security event through the network element information, and acquires accurate location information corresponding to the address information from the geographic information processing module to express the accurate location information in the geographic information.

6. The GIS based network information monitoring system of claim 1, wherein the network information processing module adds or subtracts the width of the line in proportion to the amount of traffic caused by the packet.

7. The GIS based network information monitoring system of claim 1, wherein the geographic information is a vector image.

8. The GIS based network information monitoring system of claim 7, further comprising a user interface module requesting one of zoon-in, zoom-out, rotation, and right and left symmetrical transformation of the geographic information realized by the vector image from the network information processing module in response to an input unit of a network manager.

9. The GIS based network information monitoring system of claim 1, wherein the network information processing module receives a security event through the external network device, determines the type of an attack of the packet facing the external network device through the security event, and expressing the determined type of the attack in the geographic information.

10. The GIS based network information monitoring system of claim 1, wherein the geographic information is written according to one of 2D and 3D methods.

11. The GIS based network information monitoring system of claim 1, wherein the network information processing module contains information about the IP ranges, phone numbers, addresses, latitudes and longitudes of the AS, ISP, company, and management domain, provides at least one of the information about the IP ranges, phone numbers, addresses, latitudes and longitudes of the AS, ISP, company, and management domain to the geographic information processing module, and acquires geographic information corresponding to the provided information.

12. The GIS based network information monitoring system of claim 1, wherein the external network device includes at least one of a NetFlow monitoring method and an sFlow monitoring method, and acquires event information through the at least one of a NetFlow monitoring method and an sFlow monitoring method.

13. A GIS based network information monitoring system of claim comprising:
an event processing module connected to a GIS provider system providing a GIS service by a network to receive at least one of traffic information, IP information, security event information, network element information from at least one of a network switch and a network security device; and
a network information processing module determining a location causing at least one of traffic and the security event through the IP information, requesting geographic information containing the determined location from the GIS provider system, and connecting the attack site and target site causing one of the traffic and the security event to the acquired geographic information to intuitively express the connected attack site and target site in the geographic information.
